(19) United States
(12) Patent Application Publication
(10) Pub. No.: US 2025/0292546 A1
(43) Pub. Date: Sep. 18, 2025

(54) IMAGE GENERATION APPARATUS, IMAGE GENERATION METHOD, AND RECORDING MEDIUM

(71) Applicant: NEC Corporation, Tokyo (JP)

(72) Inventors: Hiroaki HAMADA, Tokyo (JP); Tomoko MARUYAMA, Tokyo (JP); Kazuhisa TAKANO, Tokyo (JP)

(73) Assignee: NEC Corporation, Tokyo (JP)

(21) Appl. No.: 18/973,666

(22) Filed: Dec. 9, 2024

(30) Foreign Application Priority Data
Mar. 18, 2024 (JP) 2024-042089

(51) Int. Cl. G06V 10/774; G01S 13/90; G06V 10/80; G06V 10/82

(52) U.S. Cl. CPC G06V 10/774; G01S 13/90; G06V 10/806; G06V 10/82

(57) ABSTRACT

An image generation apparatus includes: at least one memory configured to store instructions; and at least one processor configured to execute the instructions to: acquire an optical image in which an object is imaged, acquire annotation data regarding the object applied to the optical image, generate a pseudo-synthetic aperture radar (SAR) image that simulates an SAR image from the optical image by conversion processing, and add the pseudo-SAR image to training data in association with annotation data.

This application is based upon and claims the benefit of priority from Japanese Patent Application No. 2024-042089, filed on Mar. 18, 2024, the disclosure of which is incorporated herein in its entirety by reference.

### TECHNICAL FIELD

The present disclosure relates to an image generation apparatus, an image generation method, and a program.

### BACKGROUND ART

In a case of creating training data of a synthetic aperture radar (SAR) image, annotation is performed for an object captured in the SAR image.

Reference Document 1 (JP 2023-163692 A) describes reading annotation data expressing a range of an object reflected in a SAR image.

### SUMMARY

One object of the present disclosure is to provide an image generation apparatus and the like capable of reducing an annotation error in creating training data of SAR images.

An image generation apparatus according to one aspect of the present disclosure includes: at least one memory configured to store instructions; and at least one processor configured to execute the instructions to: acquire an optical image in which an object is imaged, acquire annotation data regarding the object applied to the optical image, generate a pseudo-SAR image that simulates an SAR image from the optical image by conversion processing, and add the pseudo-SAR image to training data in association with annotation data.

An image generation method according to another aspect of the present disclosure includes: acquiring an optical image in which an object is imaged; acquiring annotation data regarding the object applied to the optical image; generating a pseudo-SAR image that simulates an SAR image from the optical image by conversion processing; and adding the pseudo-SAR image to training data in association with annotation data.

A program according to still another aspect of the present disclosure causes a computer to execute processing of: acquiring an optical image in which an object is imaged; acquiring annotation data regarding the object applied to the optical image; generating a pseudo-SAR image that simulates an SAR image from the optical image by conversion processing; and adding the pseudo-SAR image to training data in association with annotation data.

Each program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an image generation apparatus;

FIG. 2 is a view illustrating an example of a flow in which training data of a pseudo-SAR image is added;

FIG. 3 is a flowchart illustrating an operation of the image generation apparatus;

FIG. 4 is a view illustrating an example of a flow in which training data of an SAR image is added;

FIG. 5 is a block diagram illustrating an example of a configuration of an image generation apparatus;

FIG. 6 is a view illustrating an example of a screen that displays a pseudo-SAR image;

FIG. 7 is a view illustrating an example of a screen that displays an optical image and a pseudo-SAR image generated from the optical image in association with each other;

FIG. 8 is a view illustrating an example of a screen that displays an optical image and a pseudo-optical image generated based on the optical image;

FIG. 9 is a flowchart illustrating an operation of the image generation apparatus; and

FIG. 10 is a view illustrating an example of a hardware configuration of the image generation apparatus.

### EXAMPLE EMBODIMENT

Example embodiments of the present disclosure will be described in detail with reference to the drawings.

### First Example Embodiment

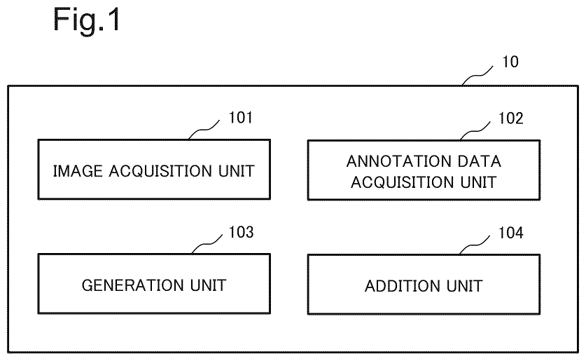

A configuration of an image generation apparatus 10 will be described with reference to FIG. 1. FIG. 1 is a block diagram illustrating an example of a configuration of an image generation apparatus 10. The image generation apparatus 10 includes an image acquisition unit 101, an annotation data acquisition unit 102, a generation unit 103, and an addition unit 104.

The image acquisition unit 101 is an aspect of image acquisition means for acquiring an optical image obtained by imaging an object. The optical image is, for example, an image captured by using an image sensor capable of observing visible light. The optical image is not limited thereto. The optical image may be an image captured by using an image sensor capable of observing near infrared rays. In addition, the optical image is, for example, an image obtained by photographing the ground surface from a satellite or an aircraft. An object is imaged in the optical image. Examples of the object include a ship, an aircraft, or a vehicle. The object is not limited thereto. The object may be an object observed by using an image.

The captured optical image is stored in, for example, a database (not illustrated). Therefore, the image acquisition unit 101 can acquire the optical image from the database. Here, the image generation apparatus 10 and the database are connected by a wired or wireless network. In addition, the image acquisition unit 101 may acquire an optical image captured by a sensor from the sensor. The image generation apparatus 10 and the sensor are connected by a wired or wireless network. The image acquisition unit 101 may acquire one optical image or may acquire a plurality of optical images.

The annotation data acquisition unit 102 is an aspect of annotation data acquisition means for acquiring annotation data regarding an object applied to the optical image.

The annotation data includes information regarding the object imaged in the optical image. Then, the annotation data is applied to the optical image. The information on the object includes information regarding a type of the object included in the optical image and information regarding a position of the object included in the optical image. That is, the annotation data is information indicating what object is imaged and is located where in the optical image.

The annotation data acquisition unit 102 acquires annotation data regarding the object imaged in the optical image, the annotation data being applied to the optical image. The annotation data acquisition unit 102 can acquire the annotation data by, for example, annotation using a trained model. The annotation data acquisition unit 102 annotates the optical image acquired by the image acquisition unit 101 by using the trained model. The annotation data acquisition unit 102 can acquire the annotation data output by the trained model.

The annotation using the trained model may be performed in an information processing apparatus (not illustrated) different from the image generation apparatus 10. In this case, the annotation data acquisition unit 102 transmits the optical image acquired by the image acquisition unit 101 to the information processing apparatus. The information processing apparatus performs annotation using the trained model. Then, the annotation data acquisition unit 102 can acquire the annotation data output by the trained model from the information processing apparatus.

The optical image and the annotation data output from the trained model for the optical image are associated with each other. Then, a known model can be used as the trained model. Furthermore, the trained model may be a model additionally trained for detection of a target imaged in an image.

The annotation data acquisition unit 102 may acquire a result of annotation performed on the optical image by a user as annotation data. The user observes the optical image acquired by the image acquisition unit 101 and annotates the object imaged in the optical image. Then, the user inputs a result of performing the annotation by using, for example, an input device (not illustrated). The annotation data acquisition unit 102 acquires the annotation data input by the user. When the user performs the annotation, the optical image and the annotation data for the optical image are associated with each other.

The annotation data input by the user may be stored, for example, in a database. In this case, the annotation data acquisition unit 102 acquires the annotation data from the database. Here, the optical image and the annotation data for the optical image are stored in the database in association with each other.

The method of acquiring the annotation data by the annotation data acquisition unit 102 is not limited thereto. The annotation for the object included in the optical image is performed by using a known technology.

For example, the annotation data acquisition unit 102 may acquire annotation data using, for example, information that assists the annotation. The accuracy of the annotation can be improved by using the information that assists the annotation. For example, when the annotation data acquisition unit 102 acquires the annotation data by annotation using the trained model, information that assists the annotation may be input to the trained model. In addition, in a case where the annotation data acquisition unit 102 acquires the annotation data by annotation by the user, the user can perform the annotation with reference to the information that assists the annotation.

An example of the information that assists the annotation is automatic identification system (AIS) information in a case where the object is a ship. When the object is a ship, the annotation data acquisition unit 102 can acquire the annotation data using the AIS information. The AIS information may include a location of the ship and a type of the ship. Therefore, when the object is a ship, the accuracy of the annotation can be improved.

The generation unit 103 is an aspect of generation means for generating a pseudo-SAR image simulating a SAR image from an optical image by conversion processing. The pseudo-SAR image is an image generated based on the optical image. The pseudo-SAR image is an image generated by conversion processing so as to look similar to the SAR image.

For the conversion processing from the optical image to the pseudo-SAR image, for example, generative adversarial networks (GAN) are used. The generation unit 103 can generate a pseudo-SAR image simulating an optical image from the optical image by using an existing GAN. The GAN may have additionally trained about generation of the pseudo-SAR image. The generation unit 103 generates one pseudo-SAR image from one optical image by using the GAN. The generation unit 103 may generate a plurality of pseudo-SAR images from one optical image by using the GAN. The method of the conversion processing from the optical image to the pseudo-SAR image is not limited thereto. The conversion processing from the optical image to the pseudo-SAR image is performed by using a known technology.

Here, the optical image and the pseudo-SAR image generated from the optical image are associated with each other. As described above, the optical image and the annotation data for the optical image are associated with each other. Therefore, the pseudo-SAR image and the annotation data for the pseudo-SAR image are associated with each other. That is, the annotation data for the optical image and the annotation data for the pseudo-SAR image generated from the optical image are the same as each other.

The generation unit 103 may generate a pseudo-optical image simulating an optical image from the pseudo-SAR image by conversion processing. That is, the generation unit 103 may generate a pseudo-optical image similar in appearance to the optical image from the pseudo-SAR image. By generating the pseudo-optical image, it is possible to increase the number of training data. The generation unit 103 can generate a pseudo-optical image from the pseudo-SAR image by using the GAN. The generation unit 103 can generate a pseudo-optical image from the pseudo-SAR image using an existing GAN. The GAN may have additionally trained about generation of the pseudo-optical image. The method of the conversion processing from the pseudo-SAR image to the pseudo-optical image is not limited thereto. The conversion processing from the pseudo-SAR image to the pseudo-optical image is performed by using a known technology.

The addition unit 104 is an aspect of addition means for adding the pseudo-SAR image to training data in association with the annotation data. The addition unit 104 adds the pseudo-SAR image to the training data. At this time, the addition unit 104 adds the pseudo-SAR image and the annotation data corresponding to the pseudo-SAR image in association with each other to the training data. As described above, the pseudo-SAR image generated by the generation unit 103 and the annotation data for the pseudo-SAR image are associated with each other. The association between the pseudo-SAR image and the annotation data for the pseudo-SAR image may be performed by, for example, a file name. The pseudo-SAR image and the annotation data for the pseudo-SAR image may be associated with each other by superimposing the annotation data on the pseudo-SAR image. A specific method of the association is not particularly limited.

The addition unit 104 can add the pseudo-SAR image and the annotation data to the training data, for example, by storing the pseudo-SAR image and the annotation data in a database in which the training data is stored. In the database, the pseudo-SAR image and the annotation data may be stored separately. For example, the pseudo-SAR image and the annotation data may be stored in different folders.

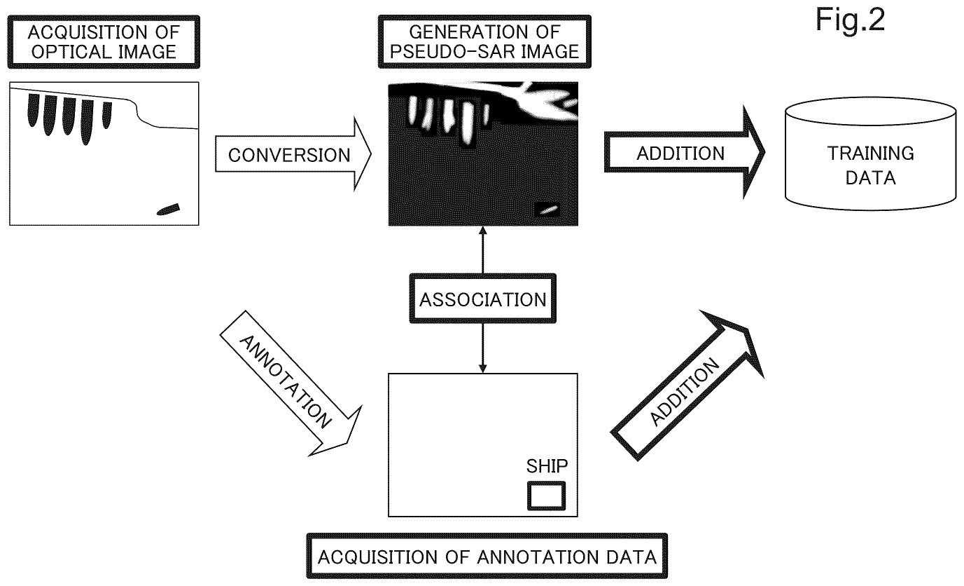

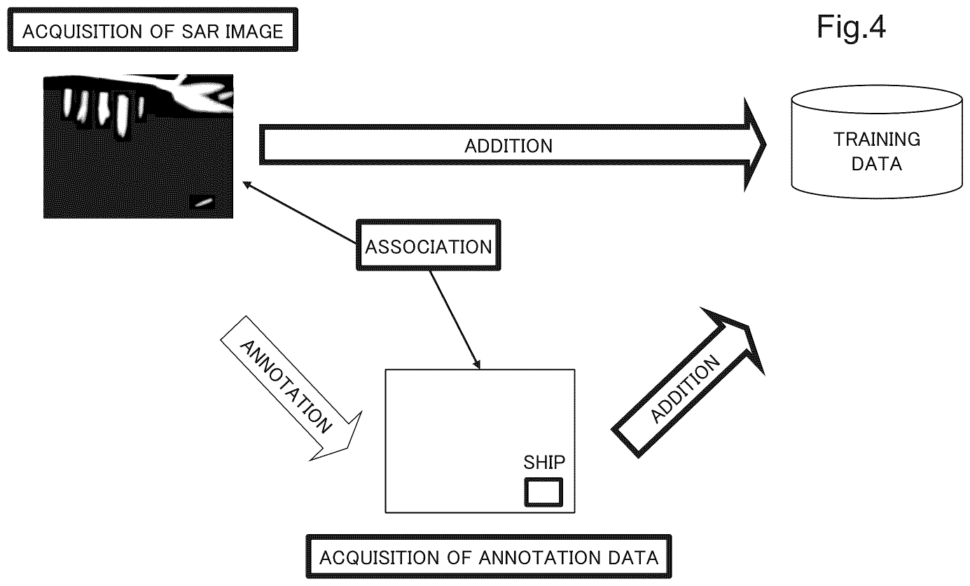

Here, a flow in which the training data of the pseudo-SAR image is added will be described with reference to FIG. 2. FIG. 2 is a view illustrating an example of a flow in which the training data of the pseudo-SAR image is added. An upper left view in FIG. 2 is an image view of an optical image acquired by the image acquisition unit 101. In the example illustrated in FIG. 2, the object is a ship. An upper center view in FIG. 2 is an image view of a pseudo-SAR image generated from the optical image by conversion processing. In addition, a lower center view in FIG. 2 is an image view of annotation data regarding the object applied to the optical image. That is, the lower center view in FIG. 2 is an image view of the annotation data acquired by the annotation data acquisition unit 102. In the image view of the annotation data, a portion represented by a black rectangle is a position of the object in the optical image. In the image view of the annotation data, a type of the object imaged in the optical image is represented as a ship. Then, in FIG. 4, the pseudo-SAR image and the annotation data are added as training data in association with each other. The addition unit 104 may distinctively add the pseudo-SAR image and the annotation data to the training data. The pseudo-SAR image on which the annotation data is superimposed may be added as the training data. The optical image, the pseudo-SAR image, and the annotation data are not limited to the example illustrated in FIG. 4. In addition, the object is not limited to the ship.

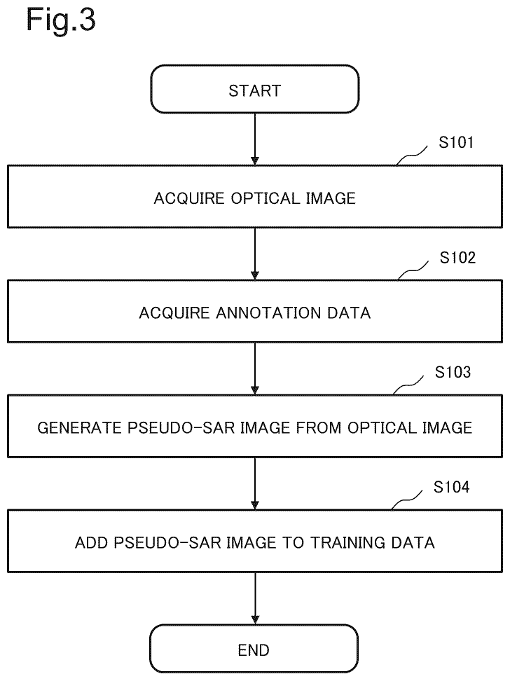

The operation of the image generation apparatus 10 including the image acquisition unit 101, the annotation data acquisition unit 102, the generation unit 103, and the addition unit 104 will be described with reference to FIG. 3. FIG. 3 is a flowchart illustrating an operation of the image generation apparatus 10.

In step S101, the image acquisition unit 101 acquires an optical image in which an object is imaged. In step S102, the annotation data acquisition unit 102 acquires the annotation data regarding the object applied to the optical image. In step S103, the generation unit 103 generates a pseudo-SAR image that simulates an SAR image from the optical image by conversion processing. In step S104, the addition unit 104 adds the pseudo-SAR image to the training data in association with the annotation data. Then, the image generation apparatus 10 terminates the operation.

The image generation apparatus 10 can repeat the above-described flow. For example, the image generation apparatus 10 may generate a pseudo-SAR image serving as training data with respect to a plurality of optical images. After step S104, the process returns to step S101, and the image acquisition unit 101 can acquire a new optical image. Then, the image generation apparatus 10 performs the operations from step S102 to step S104 on the new optical image.

In step S101, in a case where the image acquisition unit 101 acquires a plurality of optical images, the image generation apparatus 10 may repeat the operations from step S102 to step S104 for each of the optical images.

In the present example embodiment, in the image generation apparatus 10, the annotation data acquisition unit 102 acquires the annotation data regarding the object applied to the optical image. Then, the generation unit 103 generates a pseudo-SAR image simulating an SAR image from the optical image, and the addition unit 104 adds the pseudo-SAR image to the training data in association with the annotation data. When the annotation is performed on the SAR image, it may be difficult to accurately perform the annotation. Therefore, an annotation error may occur in the SAR image. Accurate annotation may be performed with the optical image as compared to the SAR image. Therefore, by performing annotation on the optical image and by adding the pseudo-SAR image generated from the optical image as training data, it is possible to reduce an annotation error in the training data creation of the SAR image.

In the SAR image, for example, an object may be confused with a noise. Therefore, as an annotation error, a noise may be annotated as an object. In addition, as another example of the annotation error, there is a case where the object included in the SAR image is not annotated as the object. That is, the object in the SAR image may be missed. However, the optical image may be easier to perform accurate annotation as compared with the SAR image. Therefore, it is possible to reduce the annotation error by performing the annotation on the optical image. The training data is used, for example, for generating a model for detection of an object included in the SAR image. By retaining the accurately annotated annotation data in combination with the pseudo-SAR image as training data, it is possible to improve the accuracy of learning using the training data.

In addition, the annotation data acquisition unit 102 may acquire annotation data using, for example, information that assists the annotation. For example, when the object is a ship, the annotation data acquisition unit 102 may acquire the annotation data using the AIS information. Accurate annotation may be possible by using information that assists the annotation. That is, in creation of the training data of the SAR image, the annotation error can be reduced.

Here, an example of the conversion processing is processing of generating a pseudo-SAR image from an optical image by using a generative adversarial network. The generation unit 103 may be able to generate a highly accurate pseudo-SAR image by generating a pseudo-SAR image from an optical image by using the generative adversarial network. Then, the addition unit 104 adds the highly accurate pseudo-SAR image as training data, and thus the accuracy of learning using the training data can be improved.

Furthermore, the image generation apparatus 10 can increase the number of training data by adding the pseudo-SAR image generated from the optical image as the training data. There is a case where the number of training data is insufficient in generation of a model for detection of an object included in the SAR image. Therefore, the generation unit 103 generates the pseudo-SAR image from the optical image, and the addition unit 104 stores the pseudo-SAR image as the training data, and thus the number of training data can be increased. As the number of training data is increased, the accuracy of learning using the training data can be improved.

### Modification Example

Modification Example will be described in detail with reference to the drawings. Hereinafter, redundant description will be omitted to an extent that description of the present example embodiment is not unclear.

In the present modification example, the image generation apparatus 10 adds an SAR image as training data in addition to the pseudo-SAR image.

The image acquisition unit 101 acquires an SAR image obtained by imaging an object. A method of acquiring the SAR image by the image acquisition unit 101 is similar to the method of acquiring the optical image by the image acquisition unit 101.

The annotation data acquisition unit 102 acquires annotation data regarding an object applied to the SAR image. The method of obtaining the annotation data for the SAR image is similar to the method of obtaining the annotation data for the optical image.

The addition unit 104 adds the SAR image to the training data in association with the annotation data. As a result, the training data includes the pseudo-SAR image and the SAR image. A method of associating the SAR image with the annotation data for the SAR image is similar to the case of the pseudo-SAR image. In addition, the method of adding the SAR image to the training data is similar to the case of the pseudo-SAR image. A ratio between the SAR image and the pseudo-SAR image included in the training data is random. The ratio between the SAR image and the pseudo-SAR image may be, for example, a ratio according to a model to be trained by using the training data. In addition, the ratio between the SAR image and the pseudo-SAR image may be, for example, a ratio corresponding to an object imaged in the image.

A flow in which training data of the SAR image is added will be described with reference to FIG. 4. FIG. 4 is a view illustrating an example of a flow in which training data of an SAR image is added. An upper left view in FIG. 4 is an image view of an SAR image acquired by the image acquisition unit 101. In the example illustrated in FIG. 4, the object is a ship. In addition, a lower view in FIG. 4 is an image view of annotation data regarding the object applied to the SAR image. That is, the lower view in FIG. 4 is an image view of the annotation data acquired by the annotation data acquisition unit 102. In the image view of the annotation data, a portion represented by a black rectangle is a position of the object in the SAR image. In addition, in the image view of the annotation data, a type of the object imaged in the SAR image is represented as a ship. Then, in FIG. 4, the SAR image and the annotation data are added as training data in association with each other. The SAR image and the annotation data may be added separately to the training data. The SAR image on which the annotation data is superimposed may be added as the annotation data. The SAR image and the annotation data are not limited to the example illustrated in FIG. 4.

In the present example embodiment, in the image generation apparatus 10, the annotation data acquisition unit 102 acquires the annotation data regarding the object applied to the SAR image, and the addition unit 104 adds the SAR image to the training data in association with the annotation data. The addition unit 104 adds the SAR image as training data, and thus the training data includes both the pseudo-SAR image and the SAR image. Since not only the pseudo-SAR image generated from the optical image but also the SAR image is included in the training data, it is possible to improve the learning accuracy in generation of the model for detection of the object included in the SAR image. In addition, by adding the SAR image to the training data, it is possible to increase the number of training data.

### Second Example Embodiment

Next, a second example embodiment of the present disclosure will be described in detail with reference to the drawings. Hereinafter, redundant description will be omitted to an extent that description of the present example embodiment is not unclear.

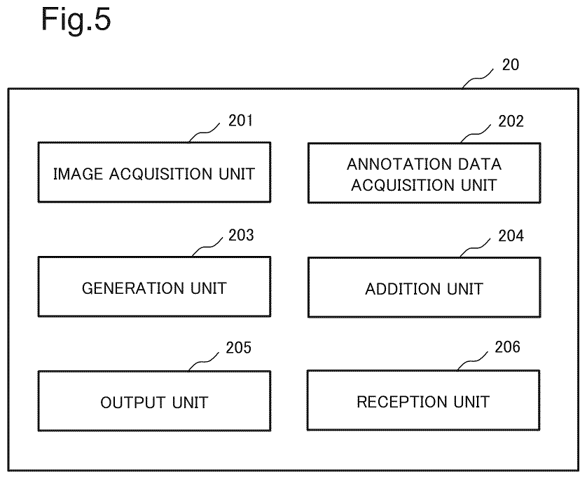

A configuration of an image generation apparatus 20 will be described with reference to FIG. 5. FIG. 5 is a block diagram illustrating an example of a configuration of the image generation apparatus 20. The image generation apparatus 20 includes an image acquisition unit 201, an annotation data acquisition unit 202, a generation unit 203, an addition unit 204, and an output unit 205. The image generation apparatus 20 may include a reception unit 206.

The image acquisition unit 201, the annotation data acquisition unit 202, the generation unit 203, and the addition unit 204 are similar as in the above-described example embodiment.

The output unit 205 is an aspect of output means for outputting a screen that displays an optical image and a pseudo-SAR image generated from the optical image in association with each other.

The output unit 205 outputs, for example, a screen to be displayed on a display device (not illustrated). The display device displays the screen output by the output unit 205. Then, a user can confirm the screen displayed on the display device. The display device and the image generation apparatus 20 are connected by a wired or wireless network.

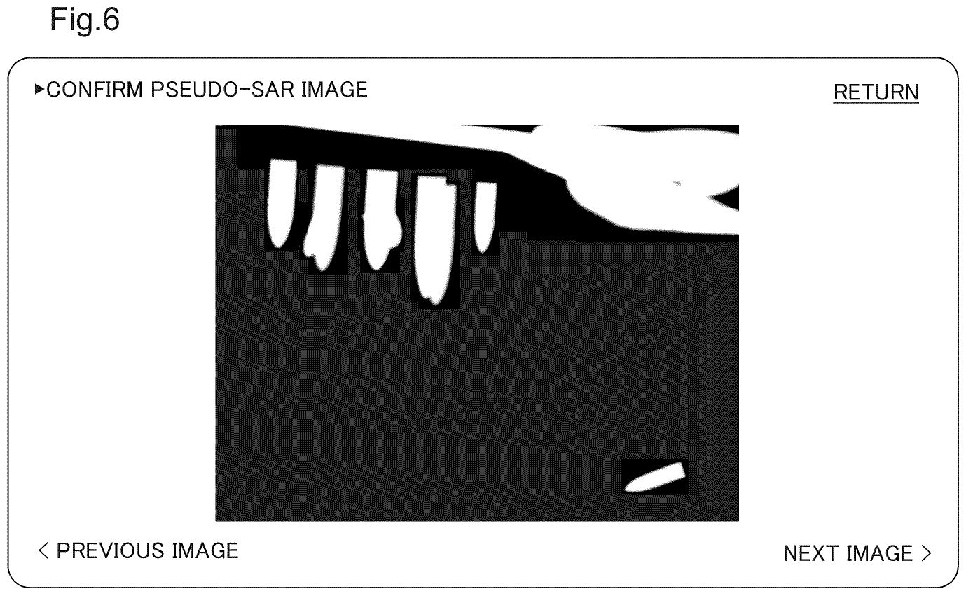

The output unit 205 outputs a screen that displays the pseudo-SAR image generated by the generation unit 203. For example, the user can confirm the pseudo-SAR image displayed on the display device. FIG. 6 is a view illustrating an example of the screen that displays the pseudo-SAR image. Referring to FIG. 6, the pseudo-SAR image generated from the optical image is displayed. When a plurality of pseudo-SAR images are generated, the user can press “next image” or “previous image” displayed on the screen. The output unit 205 can display a pseudo-SAR image different from the displayed pseudo-SAR image by pressing “next image” or “previous image” displayed on the screen.

The output unit 205 may output a screen that displays a range of an object of the annotation data in the pseudo-SAR image. Furthermore, the output unit 205 may output a screen on which the range of the object of the annotation data in the pseudo-SAR image is enlarged and displayed. The range of the object of the annotation data is, for example, a range represented by the rectangle in the example of the annotation data illustrated in FIG. 2. The range of the object of the annotation data is not limited thereto, and the range of the object of the annotation data may be, for example, a range including the entire annotated object.

The output unit 205 may output a screen that displays a pseudo-SAR image corresponding to the range designated in the optical image. For example, when acquiring an optical image, the image acquisition unit 201 can receive designation of a range to be displayed by the output unit 205. Then, the output unit 205 can output an image displaying the range of the pseudo-SAR image corresponding to the range for which the designation has been received in the optical image. The output unit 205 may output an image obtained by enlarging and displaying the range of the pseudo-SAR image corresponding to the range for which the designation has been received in the optical image. Here, reception of the designation of the range to be displayed by the output unit 205 may be performed by a configuration different from that of the image acquisition unit 201. The reception of the designation of the range to be displayed by the output unit 205 may be performed, for example, by the reception unit 206 described later.

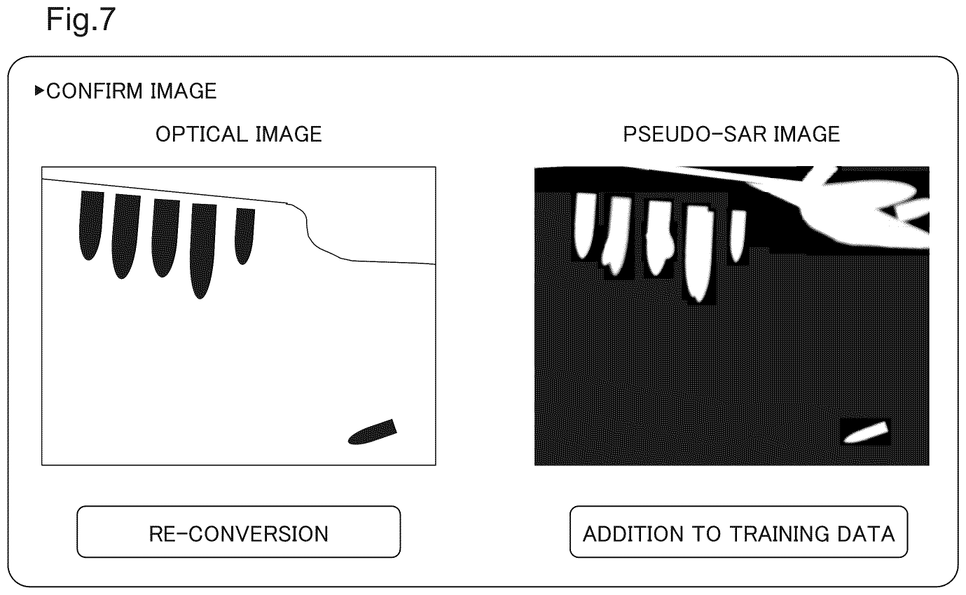

The output unit 205 outputs a screen that displays the optical image and the pseudo-SAR image generated from the optical image in association with each other. The output unit 205 can output a screen that displays the optical image and the pseudo-SAR image generated from the optical image in a comparable manner. The output unit 205 can output, for example, a screen on which an optical image and a pseudo-SAR image generated from the optical image are displayed side by side. FIG. 7 is a view illustrating an example of the screen that displays the optical image and the pseudo-SAR image generated from the optical image in association with each other. Referring to FIG. 7, the optical image and the pseudo-SAR image generated from the optical image are displayed side by side. The optical image and the pseudo-SAR image generated from the optical image are displayed side by side, and thus the user can compare the optical image with the pseudo-SAR image. A “re-conversion” button and an “addition to training data” button included in the example of the screen of FIG. 7 will be described later.

In addition, the output unit 205 can output a screen that switchably displays the optical image and the pseudo-SAR image generated from the optical image. For example, the user performs a switching operation between the optical image and the pseudo-SAR image generated from the optical image. The output unit 205 can switch an image to be displayed on the screen by the switching operation by the user. By switching the image, the user can compare the optical image with the pseudo-SAR image generated from the optical image. For example, the output unit 205 may output a screen on which the optical image and the pseudo-SAR image generated from the optical image are switched for every predetermined time. The predetermined time is time required for the user to confirm the image. For example, the predetermined time is set by the user.

The output unit 205 may output a screen that displays a range of an object of the annotation data in each of the optical image and the pseudo-SAR image displayed in association with each other. The output unit 205 may output a screen that enlarges and displays the range of the object of the annotation data in each of the optical image and the pseudo-SAR image displayed in association with each other. The range of the object of the annotation data in each of the optical image and the pseudo-SAR image is enlarged and displayed, and thus the user can compare the optical image with the pseudo-SAR image for the range of the object. The range of the object of the annotation data is as described above. The output unit 205 may output a screen that displays a range of the object of the annotation data in the optical image or the pseudo-SAR image.

The output unit 205 may output a screen that displays a range corresponding to the range designated in the optical image for the pseudo-SAR image displayed in association with the optical image. For the pseudo-SAR image, the output unit 205 may output a screen on which a range corresponding to the range designated in the optical image is enlarged and displayed. The designation of the range displayed by the output unit 205 is as described above. The output unit 205 may further output a screen that displays the range designated in the optical image. In addition, the output unit 205 may output a screen on which the range designated in the optical image is enlarged and displayed.

When the generation unit 203 generates a pseudo-optical image, the output unit 205 may output a screen that displays the optical image and the pseudo-optical image generated based on the optical image. Here, the pseudo-SAR image generated based on the optical image is a pseudo-optical image generated by the generation unit 203 from the pseudo-SAR image generated from the optical image by the generation unit 203. The output unit 205 can output a screen that displays the optical image and the pseudo-optical image in association with each other. For example, the output unit 205 may output a screen that displays the optical image and the pseudo-optical image in a comparable manner.

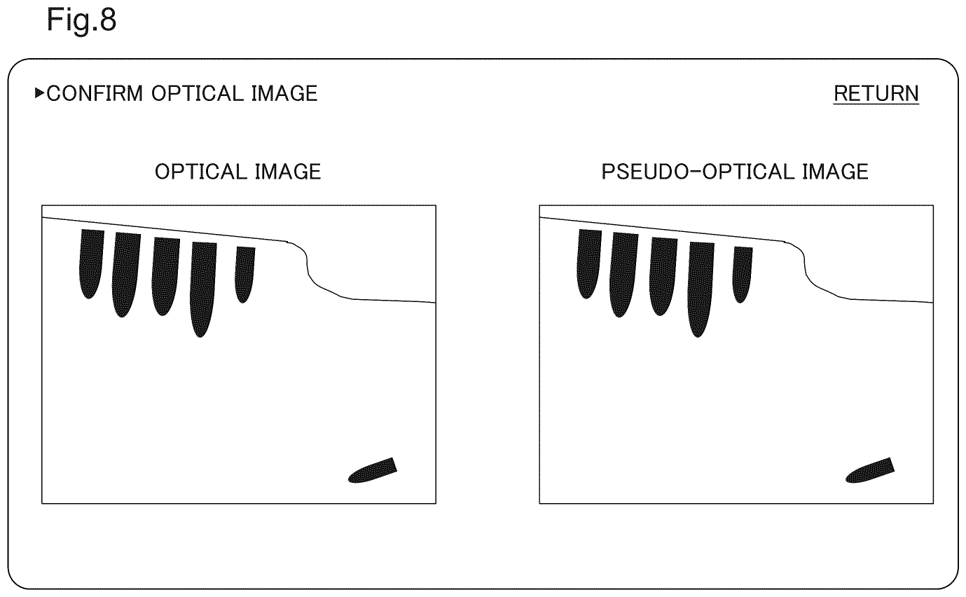

FIG. 8 is a view illustrating an example of a screen that displays the optical image and the pseudo-optical image generated based on the optical image. On the screen, the optical image and the pseudo-optical image are displayed side by side. The user can compare the optical image displayed on the screen with the pseudo-optical image. FIG. 8 is an example of the screen that displays the optical image and the pseudo-optical image generated based on the optical image. The screen that displays the optical image and the pseudo-optical image generated based on the optical image is not limited thereto. For example, the output unit 205 may output a screen that switchably displays the optical image and the pseudo-optical image generated based on the optical image.

The image generation apparatus 20 may further include a reception unit 206.

The reception unit 206 is an aspect of reception means for receiving an instruction to add the pseudo-SAR image to the training data. The reception unit 206 receives an instruction to add the pseudo-SAR image generated by the generation unit 203 to the training data. For example, the reception unit 206 may receive an instruction for the addition to the training data on the screen. The output unit 205 can output, for example, a screen capable of receiving an instruction to add the pseudo-SAR image to the training data. Then, the user can give an instruction to add the pseudo-SAR image to the training data by performing an operation on the screen. That is, the reception unit 206 may receive an instruction for addition to the training data by an operation on the screen by the user.

Reference is now made again to FIG. 7. In the example of the screen in FIG. 7, an “addition to training data” button is displayed. When the user presses the “addition to training data” button, the reception unit 206 can receive an instruction to add the pseudo-SAR image to the training data. That is, FIG. 7 is also an example of a screen capable of receiving an instruction to add the pseudo-SAR image to the training data. The screen capable of receiving the instruction to add the pseudo-SAR image to the training data is not limited thereto. The output unit 205 may output, as a screen different from the screen that displays the pseudo-SAR image, a screen capable of receiving an instruction to add the pseudo-SAR image to the training data.

The reception unit 206 may receive an instruction to add the pseudo-SAR image to the training data by voice input. For example, the user may input an instruction to add the pseudo-SAR image to the training data to an audio input device (not illustrated) with an audio. The voice input to the voice input device by the user is analyzed by voice recognition. Analysis by voice recognition is performed by using a known technology. Here, the voice input device and the image generation apparatus 20 are connected by a wired or wireless network. The method of receiving an instruction to add the pseudo-SAR image to the training data is not limited thereto.

When the reception unit 206 receives an instruction to add the pseudo-SAR image as the training data, the addition unit 204 adds the pseudo-SAR image to the training data in association with annotation data. In a case where the image generation apparatus 20 includes the reception unit 206, when the reception unit 206 receives an instruction not to add the pseudo-SAR image as the training data, the addition unit 204 may not add the pseudo-SAR image to the training data. For example, the reception unit 206 can receive an instruction not to add the pseudo-SAR image as the training data on the screen. As a specific example, a “no addition to training data” button may be displayed on the screen output by the output unit. Then, when the user presses the button, an instruction not to add the pseudo-SAR image as the training data can be received. The reception unit 206 may receive an instruction not to add the pseudo-SAR image as the training data by voice input. In addition, the reception unit 206 may receive an instruction not to add the pseudo-SAR image to the training data when not receiving an instruction to add the pseudo-SAR image to the training data within a predetermined period.

The reception unit 206 may receive an instruction to generate the pseudo-SAR image again from the optical image. When the user confirms the pseudo-SAR image generated by the generation unit 203, the user may desire to generate the pseudo-SAR image again by conversion processing. That is, the user may desire to regenerate the pseudo-SAR image. Therefore, the reception unit 206 can receive an instruction to generate the pseudo-SAR image again from the optical image.

The reception unit 206 can receive an instruction to generate the pseudo-SAR image again from the optical image on the screen. The output unit 205 can output, for example, a screen capable of receiving an instruction to generate a pseudo-SAR image again from the optical image. Then, the user can give an instruction for generation of the pseudo-SAR image again by performing an operation on the screen. That is, the reception unit 206 may receive an instruction to generate the pseudo-SAR image again by an operation on the screen by the user.

Reference is now made again to FIG. 7. In the example of the screen in FIG. 7, a “re-conversion” button is displayed. When the user presses the “re-conversion” button, the reception unit 206 can receive an instruction to generate the pseudo-SAR image again. That is, FIG. 7 is an example of a screen that can receive an instruction to generate the pseudo-SAR image again from the optical image. In the screen example illustrated in FIG. 7, an optical image and a pseudo-SAR image are displayed. Therefore, the user can compare the optical image with the pseudo-SAR image and provide an instruction to generate the pseudo-SAR image again in a case where the user considers that the pseudo-SAR image needs to be generated again.

The screen capable of receiving the instruction to generate the pseudo-SAR image again from the optical image is not limited thereto. The output unit 205 may output, as a screen different from the screen that displays the pseudo-SAR image, a screen capable of receiving an instruction to generate the pseudo-SAR image again.

The reception unit 206 may receive an instruction to generate the pseudo-SAR image again by voice input. The method of receiving an instruction to add the pseudo-SAR image to the training data is not limited thereto.

When the reception unit 206 receives the instruction to generate the pseudo-SAR image again, the generation unit 203 generates the pseudo-SAR image again from the optical image by conversion processing. Then, the addition unit 204 may add the pseudo-SAR image generated again to the training data. In addition, the output unit 205 may output a screen that displays the optical image and the pseudo-SAR image generated again from the optical image in association with each other. When the reception unit 206 receives an instruction not to generate the pseudo-SAR image again, the addition unit 204 may add the pseudo-SAR image to the training data. The reception unit 206 can receive an instruction not to generate the pseudo-SAR image again, for example, on a screen or by voice input. In addition, when not receiving the instruction to generate the pseudo-SAR image again, the reception unit 206 may receive the instruction not to generate the pseudo-SAR image again. Further, when the output unit 205 outputs a screen capable of receiving the instruction to add the pseudo-SAR image to the training data, reception of the instruction to add the pseudo-SAR image to the training data may be set as reception of an instruction not to generate the pseudo-SAR image again.

The reception unit 206 may receive designation of a range to be enlarged and displayed in the pseudo-SAR image. First, the output unit 205 can output a screen capable of enlarging and displaying the range designated in the pseudo-SAR image. Then, for example, the user can designate a range to be enlarged on the screen on which the pseudo-SAR image is displayed. At this time, the reception unit 206 can receive designation of a range to be enlarged and displayed in the pseudo-SAR image on the screen. Then, the output unit 205 may output a screen on which the range designated in the pseudo-SAR image is enlarged and displayed.

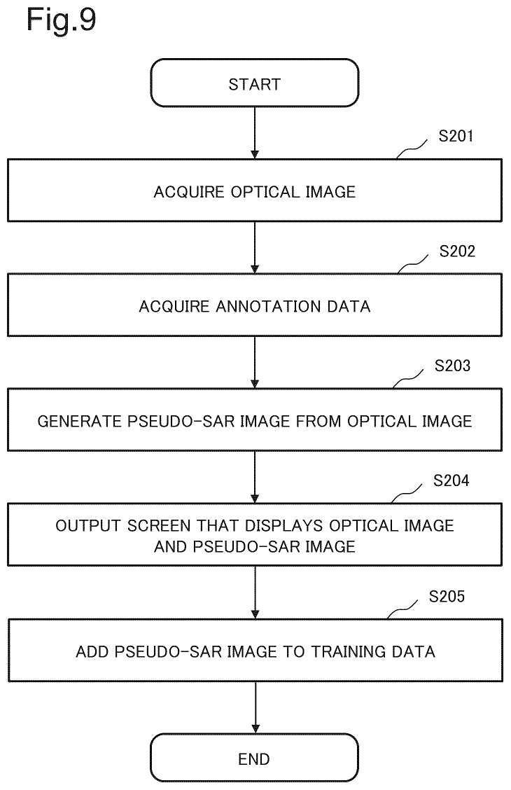

The operation of the image generation apparatus 20 including the image acquisition unit 201, the annotation data acquisition unit 202, the generation unit 203, the addition unit 204, and the output unit 205 will be described with reference to FIG. 9. FIG. 9 is a flowchart illustrating an operation of the image generation apparatus 20.

Step S201, step S202, and step S203 in FIG. 9 are the same as step S101, step S102, and step S103 in FIG. 3, respectively. In step S204, the output unit 205 outputs a screen that displays the optical image and the pseudo-SAR image in association with each other. In step S205, the addition unit 204 adds the pseudo-SAR image to the training data in association with annotation data. Then, the image generation apparatus 20 terminates the operation. Here, step S204 and step S205 may be performed in any order. That is, after the addition unit 204 adds the pseudo-SAR image as the training data, the output unit 205 may output a screen that displays the optical image and the pseudo-SAR image in association with each other. In addition, step S204 and step S205 may be performed in parallel.

The operation of the image generation apparatus 20 in a case where the image generation apparatus includes the reception unit 206 will be described. After step S204, the reception unit 206 receives an instruction to add the pseudo-SAR image to the training data. Then, in step S205, the addition unit 204 adds the pseudo-SAR image to the training data in association with annotation data. Then, the image generation apparatus 20 terminates the operation. When the reception unit 206 receives an instruction not to add the pseudo-SAR image to the training data, the image generation apparatus 20 may terminate the operation.

After step S204, the reception unit 206 may receive an instruction to generate the pseudo-SAR image again. When the reception unit 206 receives the instruction to generate the pseudo-SAR image again, the generation unit 203 generates the pseudo-SAR image again in step S203. When the reception unit 206 receives an instruction not to generate the pseudo-SAR image again, the addition unit 204 adds the pseudo-SAR image to the training data in step S205. Then, the image generation apparatus 20 terminates the operation.

The image generation apparatus 20 may repeat the above-described operation. For example, with respect to one sheet of optical image, after the pseudo-SAR image is added to the training data in step S205, the process returns to step S201, and the image acquisition unit 201 may acquire a new optical image. Then, the image generation apparatus 20 may perform the operations of step S202 to step S205 on a new optical image. In addition, in step S201, in a case where the image acquisition unit 201 acquires a plurality of optical images, the operations of step S202 to step S205 may be repeated for each optical image. In addition, in the image generation apparatus 20, after generating the pseudo-SAR image for the plurality of optical images, the output unit 205 may output a screen on which the optical image and the pseudo-SAR image are displayed in association with each other. That is, step S201 to step S203 are repeated for each of the plurality of images. Then, in step S204, the output unit 205 may output a screen that displays the optical image and the pseudo-SAR image in association with each other.

In the present example embodiment, in the image generation apparatus 20, the output unit 205 outputs a screen that displays the optical image and the pseudo-SAR image generated from the optical image in association with each other. A user may confirm the pseudo-SAR image generated from the optical image. In addition, the user may desire to compare the pseudo-SAR image with the optical image from which the pseudo-SAR image is generated. Therefore, the output unit 205 outputs a screen that displays the optical image and the pseudo-SAR image generated from the optical image in association with each other, and thus the user can confirm the optical image and the pseudo-SAR image.

The output unit 205 may output a screen that enlarges and displays a range of an object of annotation data in the pseudo-SAR image. For example, there is a case where the pseudo-SAR image that is training data is used, for example, for generating a model for detection of an object included in the SAR image. In model training, how an object included in an image is reflected may be important. Therefore, the user may desire to confirm whether conversion processing of a range including the object is successfully performed in the pseudo-SAR image. Therefore, when the output unit 205 outputs a screen on which the range of the object of the annotation data is enlarged and displayed, the user can confirm the pseudo-SAR image for the range including the object. In addition, when the range of the object of the annotation data is enlarged and displayed, the user may be able to carefully observe the range including the object.

The output unit 205 may output a screen that displays a pseudo-SAR image corresponding to the range designated in the optical image. When there is a range to be confirmed in the generated pseudo-SAR image, the user can designate the range in the optical image. Then, the output unit 205 outputs a screen on which a range of the pseudo-SAR which corresponds to the designated range is displayed. Therefore, the user can confirm the designated range.

In the present example embodiment, in the image generation apparatus 20, the generation unit 203 generates a pseudo-optical image simulating an optical image from a pseudo-SAR image by conversion processing. Then, the output unit 205 outputs a screen that displays the optical image and the pseudo-optical image. There is a case where a user desires to confirm whether the conversion processing is appropriately performed. Therefore, the generation unit 203 generates the pseudo-optical image by performing conversion processing on the pseudo-SAR image generated from the optical image. Then, the output unit 205 outputs a screen that displays the optical image acquired by the image acquisition unit 201 and the pseudo-optical image generated by the generation unit 203. The user can confirm the optical image and the pseudo-optical image via the screen. Then, the user can use the optical image and the pseudo-optical image as references for determining whether the conversion processing is appropriately performed.

In the present example embodiment, in the image generation apparatus 20, the reception unit 206 receives an instruction to add the pseudo-SAR image to training data. Then, when receiving the instruction, the addition unit 204 adds the pseudo-SAR image to the training data in association with annotation data. The user may desire to add a portion of the generated pseudo-SAR image to the training data. For example, the user may desire to confirm the generated pseudo-SAR image and determine whether to add the pseudo-SAR image to the training data. As a specific example, there is a case where the user desires to add only the pseudo-SAR image determined by the user as an image for which the conversion processing has been appropriately performed to the training data. Therefore, when the reception unit 206 receives an instruction to add the pseudo-SAR image to the training data, the addition unit 204 adds the pseudo-SAR image to the training data, and thus the pseudo-SAR image can be added to the training data according to the determination made by the user. In addition, for example, there is a case where the accuracy of the pseudo-SAR image included in the training data can be improved by adding the pseudo-SAR image determined by the user as an image for which the conversion processing has been appropriately performed to the training data.

In the present example embodiment, in the image generation apparatus 20, the reception unit 206 receives an instruction to generate the pseudo-SAR image again from the optical image. When receiving the instruction, the generation unit 203 generates the pseudo-SAR image again from the optical image by the conversion processing. There is a case where the user desires to add only the pseudo-SAR image determined by the user as an image for which the conversion processing has been appropriately performed to the training data. Then, when determining that the conversion processing has not been appropriately performed, the user may desire to cause the image generation apparatus 20 to generate the pseudo-SAR image again. That is, the user may desire that the pseudo-SAR image is generated again. Therefore, when the reception unit 206 receives an instruction to generate the pseudo-SAR image again, the generation unit 203 generates the pseudo-SAR image again from the optical image, and thus the pseudo-SAR image can be generated according to the intention of the user. In addition, when the pseudo-SAR image is generated again, the accuracy of the pseudo-SAR image can be improved.

### [Hardware Configuration Example]

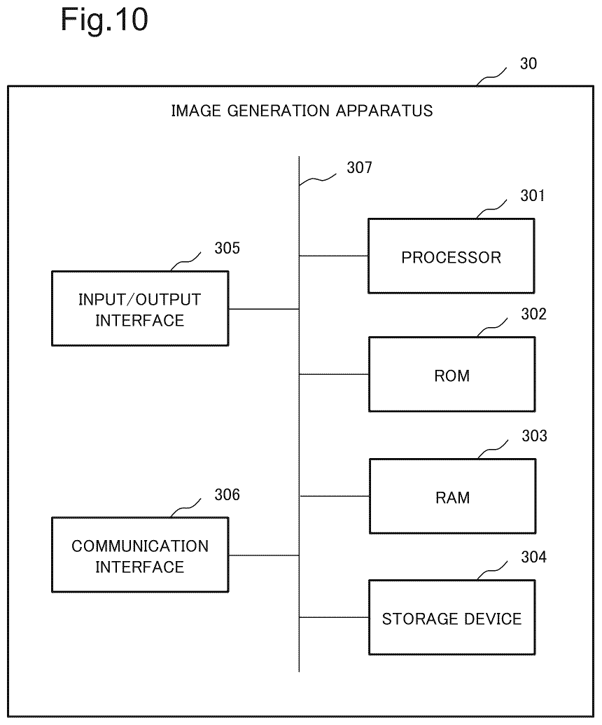

FIG. 10 is a view illustrating a hardware configuration example of an image generation apparatus 30 according to the present disclosure. The image generation apparatus 30 is achieved by a computer. The image generation apparatus 30 is an example in a case where the image generation apparatus 10 or the image generation apparatus 20 is achieved by a computer.

The image generation apparatus 30 includes a processor 301, a read only memory (ROM) 302, a random access memory (RAM) 303, a storage device 304 such as a hard disk that stores a program, an input/output interface 305 that inputs/outputs data, and a communication interface 306 for network connection. The respective constituent units are connected via a bus 307.

The processor 301 operates an operating system to control the entirety of the computer. Examples of the processor 301 include a central processing unit (CPU), a digital signal processor (DSP), and a graphics processing unit (GPU). The processor 301 loads a program stored, for example, in the ROM 302, the storage device 304, or the like. Then, the processor 301 executes each process coded in the program. The processor 301 may execute processing or instructions in the illustrated flowchart based on the program.

The ROM 302 stores an application program, a program according to each example embodiment, and the like. In addition, the RAM 303 is used as a work area of the processor 301.

Examples of the storage device 304 include a semiconductor memory such as a flash memory, a hard disk drive (HDD), and the like. The storage device 304 stores, for example, an operating system (OS) program, an application program, a program according to each example embodiment, and the like.

The input/output interface 305 is connected to a peripheral device (not illustrated). A connection method may be a wired network or a wireless network.

The communication interface 306 is connected to a communication network (not illustrated) such as a local network (LAN) or a wide area network (WAN) through a wireless or wired network. Note that, the communication network may include a plurality of communication networks. As a result, the computer is connected to an external device via the communication network. The image generation apparatus 30 may include constituent elements other than those illustrated in FIG. 10. For example, the image generation apparatus 30 may include a drive device or the like. For example, the processor 301 may be mounted on a drive device or the like, and may read a program or data stored in a non-transitory tangible recording medium into the RAM 303.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

Some or all of the above-described example embodiments may be described as the following Supplementary Notes, but are not limited to the following description.

### (Supplementary Note 1)

An image generation apparatus including:
image acquisition means for acquiring an optical image in which an object is imaged;
annotation data acquisition means for acquiring annotation data regarding the object applied to the optical image;
generation means for generating a pseudo synthetic aperture radar (SAR) image that simulates an SAR image from the optical image by conversion processing; and
addition means for adding the pseudo-SAR image to training data in association with annotation data.

### (Supplementary Note 2)

The image generation apparatus according to Supplementary Note 1, further including:
output means for outputting a screen that displays the optical image and the pseudo-SAR image generated from the optical image in association with each other.

### (Supplementary Note 3)

The image generation apparatus according to Supplementary Note 2, wherein
the output means outputs a screen on which a range of the object of the annotation data in the pseudo-SAR image is enlarged and displayed.

### (Supplementary Note 4)

The image generation apparatus according to Supplementary Note 2 or 3, wherein
the output means outputs a screen that displays the pseudo-SAR image corresponding to a range designated in the optical image.

### (Supplementary Note 5)

The image generation apparatus according to Supplementary Note 4, wherein
the generation means generates a pseudo-optical image that simulates the optical image from the pseudo-SAR image by conversion processing.

### (Supplementary Note 6)

The image generation apparatus according to Supplementary Note 5, wherein
the output means outputs a screen that displays the optical image and the pseudo-optical image.

### (Supplementary Note 7)

The image generation apparatus according to any one of Supplementary Notes 2 to 6, further including:
reception means for receiving an instruction to add the pseudo-SAR image to the training data,
wherein the addition means adds the pseudo-SAR image to the training data in association with the annotation data in a case where the instruction is received.

### (Supplementary Note 8)

The image generation apparatus according to Supplementary Note 7, wherein
the reception means receives an instruction to generate the pseudo-SAR image again from the optical image, and
the generation means generates the pseudo-SAR image again from the optical image by the conversion processing in a case where the instruction is received.

### (Supplementary Note 9)

The image generation apparatus according to any one of Supplementary Notes 1 to 8, wherein
the image acquisition means acquires an SAR image in which the object is imaged,
the annotation data acquisition means acquires annotation data regarding the object applied to the SAR image, and
the addition means adds the SAR image to the training data in association with the annotation data.

### (Supplementary Note 10)

The image generation apparatus according to any one of Supplementary Notes 1 to 9,
wherein the conversion processing is processing of generating the pseudo-SAR image from the optical image by using a generative adversarial network.

### (Supplementary Note 11)

The image generation apparatus according to any one of Supplementary Notes 1 to 10, wherein
in a case where the object is a ship, the annotation data acquisition means acquires the annotation data using information of an automatic identification system (AIS)

### (Supplementary Note 12)

An image generation method including:
acquiring an optical image in which an object is imaged;
acquiring annotation data regarding the object applied to the optical image;
generating a pseudo-synthetic aperture radar (SAR) image that simulates an SAR image from the optical image by conversion processing; and
adding the pseudo-SAR image to training data in association with annotation data.

### (Supplementary Note 13)

A program that causes a computer to execute processing of:
acquiring an optical image in which an object is imaged;
acquiring annotation data regarding the object applied to the optical image;
generating a pseudo-synthetic aperture radar (SAR) image that simulates an SAR image from the optical image by conversion processing; and
adding the pseudo-SAR image to training data in association with annotation data.

### (Supplementary Note 14)

A recording medium storing a program that causes a computer to execute processing of:
acquiring an optical image in which an object is imaged;
acquiring annotation data regarding the object applied to the optical image;
generating a pseudo-synthetic aperture radar (SAR) image that simulates an SAR image from the optical image by conversion processing; and
adding the pseudo-SAR image to training data in association with annotation data.

Some or all of the configurations described in the supplementary Notes 2 to 11 dependent on Supplementary Note 1 described above can also depend on Supplementary Notes 12 to 14 in the same dependency relationship as in the Supplementary Notes 2 to 11. Without limitation to Supplementary Notes 1, and 12 to 14, within a scope not departing from the above-described example embodiments, some or all of the configurations described as the supplementary notes may depend on various kinds of hardware, various kinds of software, various recording devices for recording software, or systems.

1. An image generation apparatus comprising:
at least one memory configured to store instructions; and
at least one processor configured to execute the instructions to:
acquire an optical image in which an object is imaged,
acquire annotation data regarding the object applied to the optical image,
generate a pseudo-synthetic aperture radar (SAR) image that simulates an SAR image from the optical image by conversion processing, and
add the pseudo-SAR image to training data in association with annotation data.

2. The image generation apparatus according to claim 1, wherein the at least one processor is further configured to execute the instructions to:
output a screen that displays the optical image and the pseudo-SAR image generated from the optical image in association with each other.

3. The image generation apparatus according to claim 2, wherein the at least one processor is further configured to execute the instructions to:
output a screen on which a range of an object of the annotation data in the pseudo-SAR image is enlarged and displayed.

4. The image generation apparatus according to claim 2, wherein the at least one processor is further configured to execute the instructions to:
output a screen that displays the pseudo-SAR image corresponding to a range designated in the optical image.

5. The image generation apparatus according to claim 4, wherein the at least one processor is further configured to execute the instructions to:
generate a pseudo-optical image that simulates the optical image from the pseudo-SAR image by conversion processing.

6. The image generation apparatus according to claim 5, wherein the at least one processor is further configured to execute the instructions to:
output a screen that displays the optical image and the pseudo-optical image.

7. The image generation apparatus according to claim 2, wherein the at least one processor is further configured to execute the instructions to:
receive an instruction to add the pseudo-SAR image to training data; and
add the pseudo-SAR image to the training data in association with the annotation data in a case where the instruction is received.

8. The image generation apparatus according to claim 7, wherein the at least one processor is further configured to execute the instructions to:
receive an instruction to generate the pseudo-SAR image again from the optical image; and
generate the pseudo-SAR image again from the optical image by the conversion processing in a case where the instruction is received.

9. The image generation apparatus according to claim 1, wherein the at least one processor is further configured to execute the instructions to:
acquire an SAR image in which the object is imaged;
acquire annotation data regarding the object applied to the SAR image; and
add the SAR image to the training data in association with the annotation data.

10. The image generation apparatus according to claim 1, wherein
the conversion processing is processing of generating the pseudo-SAR image from the optical image by using a generative adversarial network.

11. The image generation apparatus according to claim 1, wherein the at least one processor is further configured to execute the instructions to:
acquire the annotation data using automatic identification system (AIS) information in a case where the object is a ship.

12. An image generation method comprising:
acquiring an optical image in which an object is imaged;
acquiring annotation data regarding the object applied to the optical image;
generating a pseudo-synthetic aperture radar (SAR) image that simulates an SAR image from the optical image by conversion processing; and
adding the pseudo-SAR image to training data in association with annotation data.

13. The image generation method according to claim 12, further comprising:
outputting a screen that displays the optical image and the pseudo-SAR image generated from the optical image in association with each other.

14. The image generation method according to claim 13, further comprising:
outputting a screen on which a range of an object of the annotation data in the pseudo-SAR image is enlarged and displayed.

15. The image generation method according to claim 13, further comprising:
outputting a screen that displays the pseudo-SAR image corresponding to a range designated in the optical image.

16. A non-transitory computer-readable recording medium that records a program for causing a computer to execute:
acquiring an optical image in which an object is imaged;
acquiring annotation data regarding the object applied to the optical image;
generating a pseudo synthetic aperture radar (SAR) image that simulates an SAR image from the optical image by conversion processing; and
adding the pseudo-SAR image to training data in association with annotation data.

17. The recording medium, according to claim 16, that records the program for causing the computer to further execute:
outputting a screen that displays the optical image and the pseudo-SAR image generated from the optical image in association with each other.

18. The recording medium, according to claim 17, that records the program for causing the computer to further execute:
outputting a screen on which a range of an object of the annotation data in the pseudo-SAR image is enlarged and displayed.

19. The recording medium, according to claim 17, that records the program for causing the computer to further execute:
outputting a screen that displays the pseudo-SAR image corresponding to a range designated in the optical image.
